(19) United States
(12) Patent Application Publication
(10) Pub. No.: US 2025/0030258 A1
(43) Pub. Date: Jan. 23, 2025

(54) Electronic Pendant for Pets and Pet Collar With the Same

(71) Applicant: Zhongshan Great-pet Internationl Co., Ltd, Zhongshan City (CN)

(72) Inventor: Yin Lin, Zhongshan City (CN)

(21) Appl. No.: 18/354,029

(22) Filed: Jul. 18, 2023

(51) Int. Cl. H02J 7/00; A01K 27/00; F21S 9/02; F21V 23/06

(52) U.S. Cl. CPC H02J 7/0063; A01K 27/006; F21S 9/02; F21V 23/06; H02J 7/0048; A01K 27/001

(57) ABSTRACT

An electronic pendant for pet includes a pendant body, a light belt, a battery management module, and a display screen. The pendant body is provided with an accommodated cavity for receiving a battery for supplying power, an outer edge of the pendant body is provided with a transparent structure that can transmit light. The light strip is fixed in the transparent structure and is electrically connected with the battery. The battery management module includes a processor and an electricity meter, in which the electricity meter is electrically connected to the battery to measure the remaining electric quantity of the battery, and the processor is electrically connected to the electricity meter to output a measurement result of the electricity meter. The display screen is arranged on the front surface of the pendant body and is electrically connected to the processor to display the measurement result of the electricity meter.

### FIELD OF THE INVENTION

The present invention relates to the technical field of pet products, more particularly, to an electronic pendant for pets and a pet collar with the same.

### BACKGROUND OF THE INVENTION

A built-in battery is usually provided in a pet electronic product to enable the electronic product to work normally. For example, a pet collar usually has a lamp for emitting light, the lamp is normally operated by supplying power by the set battery so that a host can identify his pet in a dark environment. However, the existing pet electronic products do not have the function of displaying electric quantity, such as in a pet collar, the battery may cause sudden power-off during use, and the lamb cannot be lit, which causes the problem of the pet getting lost.

### SUMMARY OF THE INVENTION

The object of the present invention is to provide an electronic pendant for pets and a pet collar with the same, aiming to solve the problem that the existing pet electronic products do not have the function of displaying electric quantity.

In order to achieve the above objective, the present invention for pets provides an electronic pet pendant, which includes a pendant body, a light belt, a battery management module, and a display screen.

The pendant body is provided with an accommodated cavity for receiving a battery for supplying power, and the outer edge of the pendant body is provided with a transparent structure that can transmit light.

The light strip is fixed in the transparent structure and is coupled electrically with the battery.

The battery management module includes a processor and an electricity meter, in which the electricity meter is electrically connected to the battery to measure the remaining electric quantity of the battery, and the processor is electrically connected to the electricity meter to output a measurement result of the electricity meter.

The display screen is arranged on the front surface of the pendant body and is electrically connected to the processor to display the measurement result of the electricity meter.

Optionally, the front surface of the pendant body is provided with several input buttons, which are electrically connected to the processor so as to input a command to the processor.

Optionally, the front surface of the pendant body is provided with a switch button, which is electrically connected to the light strip and the battery.

Optionally, the transparent structure extends along the outer edge of the pendant body so as to form a circular structure.

Optionally, the pendant body comprises a front cover and a rear cover disposed opposite to each other; the front cover is detachably connected to the rear cover; and the transparent structure is disposed between the front cover and the rear cover.

Optionally, the pendant body is provided with a charging socket, which is electrically connected to the battery.

Optionally, the interior of the pendant body is provided with an NFC chip that can be recognized by an NFC terminal module.

Optionally, the pendant body is connected with a fixed buckle.

The foregoing one or more technical solutions of the electronic pendant for pets provided by the embodiment of the present invention have at least one of the following technical effects:

The electronic pendant for pets has the battery management module used for measuring the remaining electric quantity of the battery and the display screen for displaying the remaining electric quantity of the battery so that the client can motor the remaining electric quantity of the battery at any time at any place, and charge to the battery or replace the battery in time.

The present invention also provides a pet collar, which includes the above electronic pendant for pet.

Optionally, the pet collar includes a collar body, and the pendant body is detachably connected to the collar body.

The foregoing one or more technical solutions of the pet collar provided by the embodiment of the present invention have at least one of the following technical effects:

The collar body is worn on the necklace of the pet, the collar body is connected to the electronic pendant. The electronic pendant for pets has the battery management module used for measuring the remaining electric quantity of the battery and the display screen for displaying the remaining electric quantity of the battery so that the client can motor the remaining electric quantity of the battery at any time at any place, and charge to the battery or replace the battery in time.

### BRIEF DESCRIPTION OF THE DRAWINGS

In order to more clearly explain the technical schemes in the embodiments of the present invention, the following will briefly introduce the embodiments or the drawings needed in the description of the prior art. It is obvious that the drawings in the following description are only some embodiments of the present invention, For those skilled in the art, other drawings may also be obtained from them without creative labor.

FIG. 1 is a perspective of the pendant body according to the embodiment in the present invention.

FIG. 2 is a diagram of the the battery management module 40 according to the embodiment in the present invention.

FIG. 3 is a perspective of the collar body according to the embodiment in the present invention.

The reference numbers are as follows:

| | | |
|---|---|---|
| 10- the pendant body | 11 - the transparent structure | 12-the input buttons |
| 13-the switch button | 14 - the battery | 15 - the front cover |
| 16 - the rear cover | 17 - charging socket | 18 - NFC chip |
| 19 - the fixed buckle | 20-the light strip | 30 - the display screen |
| 40 - the battery management module | | 100- the collar body. |

### DETAILED DESCRIPTION OF ILLUSTRATED EMBODIMENTS

The embodiments of the present invention will be described in detail below. Examples of the embodiments are shown in the drawings, where the same or similar reference numerals throughout indicate the same or similar elements or elements having the same or similar functions. The embodiments described below by referring to the accompanying drawings are exemplary and are intended to be used to explain the embodiments of the present invention, but cannot be understood as limiting the present invention.

In the description of the embodiments of the present invention, it should be understood that the directional indications involved in the embodiments, such as the “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specified azimuth, which cannot be understood as a limitation of the present invention.

In addition, the terms “first” and “second” are only for descriptive purposes, and cannot be understood as indicating or implying relative importance or implicitly indicating the number of indicated technical features. Thus, the features defined as “first” and “second” may explicitly or implicitly include one or more of the features. In the description of the embodiments of the present invention, “multiple” means two or more, unless otherwise specifically defined.

In the embodiments of the present invention, unless otherwise specified and defined, the terms “installation”, “connection”, “connection”, “fixation” and other terms shall be understood in a broad sense, for example, they can be fixed connection, detachable connection, or integrated; It may be a mechanical connection or an electrical connection; It can be directly connected or indirectly connected through an intermediate medium. It can be the connection between two elements or the interaction between two elements. For those skilled in the art, the specific meanings of the above terms in the embodiments of the present invention can be understood according to specific circumstances.

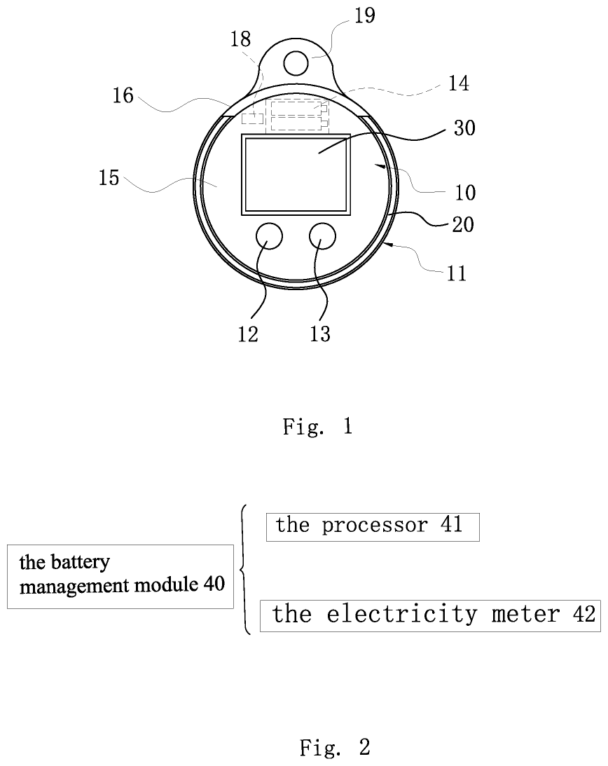

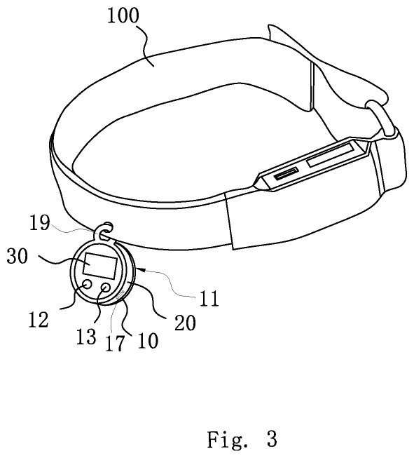

In an embodiment in the present invention, as shown in FIGS. 1-3, an electrical pendant for pets, which is worn on the pet, includes a pendant body 10, a light strip 20, a battery management module 40, and a display screen 30.

Wherein, the pendant body 10 is provided with an accommodated cavity for receiving a battery 14 for supplying power, an outer edge of the pendant body 10 is provided with a transparent structure 11 that can transmit light.

Wherein, the light strip 20 is fixed in the transparent structure 11 and is electrically connected with the battery 14.

Wherein, referring to FIG. 2, the battery management module 40 includes a processor 41 and an electricity meter 42, and the processor 41 and the electricity meter 42 are contained in the accommodated cavity. The electricity meter 42 is electrically connected to the battery 14 to measure the remaining electric quantity of the battery 14, and the processor 41 is electrically connected to the electricity meter 42 to output a measurement result of the electricity meter.

Wherein, the display screen 30 is arranged on the front surface of the pendant body 10 and is electrically connected to the processor to display the measurement result of the electricity meter.

In the present invention, the electronic pendant for pets has the battery management module 40 used for measuring the remaining electric quantity of the battery and the display screen 30 for displaying the remaining electric quantity of the battery 14, so that the client can motor the remaining electric quantity of the battery 14 at any time at any place, and charge to the battery 14 or replace the battery 14 in time.

In the other embodiment in the present invention, the front surface of the pendant body 10 is provided with input buttons 12, which are electrically connected to the processor 41 so as to input a command to the processor 41. After pressing down the input buttons 12, the input buttons 12 send the command to the processor 41, the processor 41 inputs the measurement result of the battery management module to the display screen 30. Specifically, the working principles and uses of the processor 41 are well known to those skilled in the art and are not described herein.

In the other embodiment in the present invention, the front surface of the pendant body 10 is provided with a switch button 13, which is electrically connected to the light strip 20 and the battery 14. The switch button 13 is used for controlling the turn-on or power-off of the light strip 20; when the light strip 20 is required to operate to emit light, the switch button 13 is pressed to enable the light strip 20 to be electrically connected; light rays generated by the light strip 20 penetrate the transparent structure 11 so that it is facilitated to position the pet at night. When the switch button 13 is pressed again, the light strip 20 is powered off and stops emitting light.

In the other embodiment in the present invention, the transparent structure extends along the outer edge of the pendant body 10 so as to form a circular structure, thereby increasing the coverage area of the transparent structure and the lighting area of the pendant body 10 so that the electronic pendant for pets can be easily identified at night.

In the other embodiment in the present invention, the pendant body 10 comprises a front cover 15 and a rear cover 16 arranged opposite to each other; the transparent structure 11 is disposed between the front cover 15 and the rear cover 16, and the front cover 15 is detachably connected to the rear cover 16 so that it is facilitated to detach, replace and assemble the battery 14.

In the other embodiment in the present invention, the pendant body 10 is provided with a charging socket 17, which is electrically connected to the battery 14. When the remaining electric quantity of the battery 14 is less, the external power is inserted into the charging socket 17 for powering the battery 14.

In the other embodiment in the present invention, the interior of the pendant body 10 is provided with an NFC chip 18 that can be recognized by an NFC terminal module. The NFC terminal module can be disposed in a food basin for pets. When a pet wearing the electronic pendant eats the food in the food basin, the NFC terminal module reads the NFC chip 18 in the electronic pendant, so as to perform fact monitoring on the pet's diet.

In the other embodiment in the present invention, the pendant body is connected with a fixed buckle 19, which is convenient for fixing the pendant body 10 and has strong practicality.

In the other embodiment in the present invention, the present invention also provides a pet collar, which includes the above electronic pendant. The pet collar includes a collar body 100, and the pendant body 10 is detachably connected to the collar body 100. The collar body 100 can be worn on the necklace of the pet. The collar body 100 is connected to the electronic pendant. The electronic pendant for pets has the battery management module used for measuring the remaining electric quantity of the battery and the display screen 30 for displaying the remaining electric quantity of the battery so that the client can motor the remaining electric quantity of the battery at any time at any place, and charge to the battery or replace the battery in time.

The foregoing descriptions are merely exemplary embodiments of the present invention, but are not intended to limit the present invention. Any modification, equivalent replacement, and improvement made within the spirit and principle of the present invention shall belong to the scope of protection of the present invention.

What is claimed is:

1. An electronic pendant for pets, comprising:
a pendant body, having an accommodated cavity for receiving a battery for supplying power, an outer edge of said pendant body is provided with a transparent structure that can transmit light;
a light belt, fixed in said transparent structure and electrically connected with said battery;
a battery management module, comprising a processor and an electricity meter, said electricity meter is electrically connected to said battery to measure said remaining electric quantity of said battery, and said processor is electrically connected to said electricity meter to output a measurement result of said electricity meter; and,
a display screen, arranged on a front surface of said pendant body, and electrically connected to said processor to display said measurement result of said electricity meter.

2. The electronic pendant for pets according claim 1, wherein said front surface of said pendant body is provided with several input buttons, which are electrically connected with said processor so as to input a command to said processor.

3. The electronic pendant for pets according claim 1, wherein said front surface of said pendant body is provided with a switch button, which is electrically connected to said light strip and said battery.

4. The electronic pendant for pets according claim 1, wherein said transparent structure extends along an outer edge of said pendant body so as to form a circular structure.

5. The electronic pendant for pets according claim 1, wherein said pendant body comprises a front cover and a rear cover disposed opposite to each other; said front cover is detachably connected to said rear cover; and said transparent structure is disposed between said front cover and said rear cover.

6. The electronic pendant for pets according claim 1, wherein said pendant body is provided with a charging socket, which is electrically connected to said battery.

7. The electronic pendant for pets according claim 1, wherein an interior of said pendant body is provided with an NFC chip that can be recognized by an NFC terminal module.

8. The electronic pendant for pet according claim 1, wherein said pendant body is connected with a fixed buckle.

9. A pet collar, wherein comprising an electronic pendant for pets, said electronic pendant for pets, comprising:
a pendant body, having an accommodated cavity for receiving a battery for supplying power, an outer edge of said pendant body is provided with a transparent structure that can transmit light;
a light belt, fixed in said transparent structure and electrically connected with said battery;
a battery management module, comprising a processor and an electricity meter, said electricity meter is electrically connected to said battery to measure said remaining electric quantity of said battery, and said processor is electrically connected to said electricity meter to output a measurement result of said electricity meter; and,
a display screen, arranged on a front surface of said pendant body, and electrically connected to said processor to display said measurement result of said electricity meter.

10. The pet collar according to claim 9, wherein further comprising a collar body, said pendant body is detachably connected to said collar body.
